(19) United States
(12) Patent Application Publication
(10) Pub. No.: US 2015/0201448 A1
(43) Pub. Date: Jul. 16, 2015

(54) UPLINK PILOT CHANNEL POSITIONING FOR CIRCUIT SWITCHED FALLBACK

(71) Applicant: QUALCOMM Incorporated, San Diego, CA (US)

(72) Inventors: Ming YANG, San Diego, CA (US); Tom CHIN, San Diego, CA (US); Guangming SHI, San Diego, CA (US)

(73) Assignee: QUALCOMM Incorporated, San Diego, CA (US)

(21) Appl. No.: 14/154,025

(22) Filed: Jan. 13, 2014

(51) Int. Cl. H04W 76/02; H04W 74/00

(52) U.S. Cl. CPC H04W 76/027; H04W 74/004; H04W 74/0833

(57) ABSTRACT

A method of wireless communication manages the positioning of uplink pilot channel transmissions. A random access request is transmitted at a first location indicated in a circuit switched fall back (CSFB) redirection message. The random access request is then retransmitted at a second location when a response is not received for the random access request transmitted at the first location.

### BACKGROUND

1. Field

Aspects of the present disclosure relate generally to wireless communication systems, and more particularly, to manage the positioning of uplink pilot channel (UpPCH) transmissions to mitigate random access channel (RACH) procedure failure in a network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (WCDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect, a method of wireless communication is disclosed. The method includes transmitting a random access request at a first location indicated in a circuit switched fall back (CSFB) redirection message. The method also includes retransmitting the random access request at a second location when a response is not received for the random access request transmitted at the first location.

Another aspect discloses wireless communication having a memory and at least one processor coupled to the memory. The processor(s) is configured to transmit a random access request at a first location indicated in a circuit switched fall back (CSFB) redirection message. The processor(s) is also configured to retransmit the random access request at a second location when a response is not received for the random access request transmitted at the first location.

Another aspect discloses a computer program product for wireless communications in a wireless network having a non-transitory computer-readable medium. The computer readable medium has non-transitory program code recorded thereon which, when executed by the processor(s), causes the processor(s) to perform operations of transmitting a random access request at a first location indicated in a circuit switched fall back (CSFB) redirection message. The program code also causes the processor(s) to retransmit the random access request at a second location when a response is not received for the random access request transmitted at the first location.

Another aspect discloses an apparatus including means for transmitting a random access request at a first location indicated in a circuit switched fall back (CSFB) redirection message. The apparatus also includes means for retransmitting the random access request at a second location when a response is not received for the random access request transmitted at the first location.

In one aspect, a method of wireless communication is disclosed. The method includes dynamically informing another radio access technology (RAT) of a location change for a random access channel request location.

Another aspect discloses wireless communication having a memory and at least one processor coupled to the memory. The processor(s) is configured to dynamically inform another radio access technology (RAT) of a location change for a random access channel request location.

Another aspect discloses a computer program product for wireless communications in a wireless network having a non-transitory computer-readable medium. The computer readable medium has non-transitory program code recorded thereon which, when executed by the processor(s), causes the processor(s) to perform the operation of dynamically informing another radio access technology (RAT) of a location change for a random access channel request location.

Another aspect discloses an apparatus including means for receiving an indication from a user equipment (UE) to change a location for a random access request. The apparatus also includes means for dynamically informing another radio access technology (RAT) of a location change for a random access channel request location.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a call flow diagram according to one aspect of the present disclosure.

FIG. 6 is a block diagram illustrating uplink pilot channel (UpPCH) positions.

FIG. 7 is a block diagram illustrating a method for dynamically configuring a random access retransmission location according to one aspect of the present disclosure.

FIG. 8 is a diagram illustrating an example of a hardware implementation for an apparatus employing a processing system according to one aspect of the present disclosure.

FIG. 9 is a block diagram illustrating a method for dynamically informing another RAT of a RACH location change according to one aspect of the present disclosure.

FIG. 10 is a diagram illustrating an example of a hardware implementation for an apparatus, such as a node B, employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

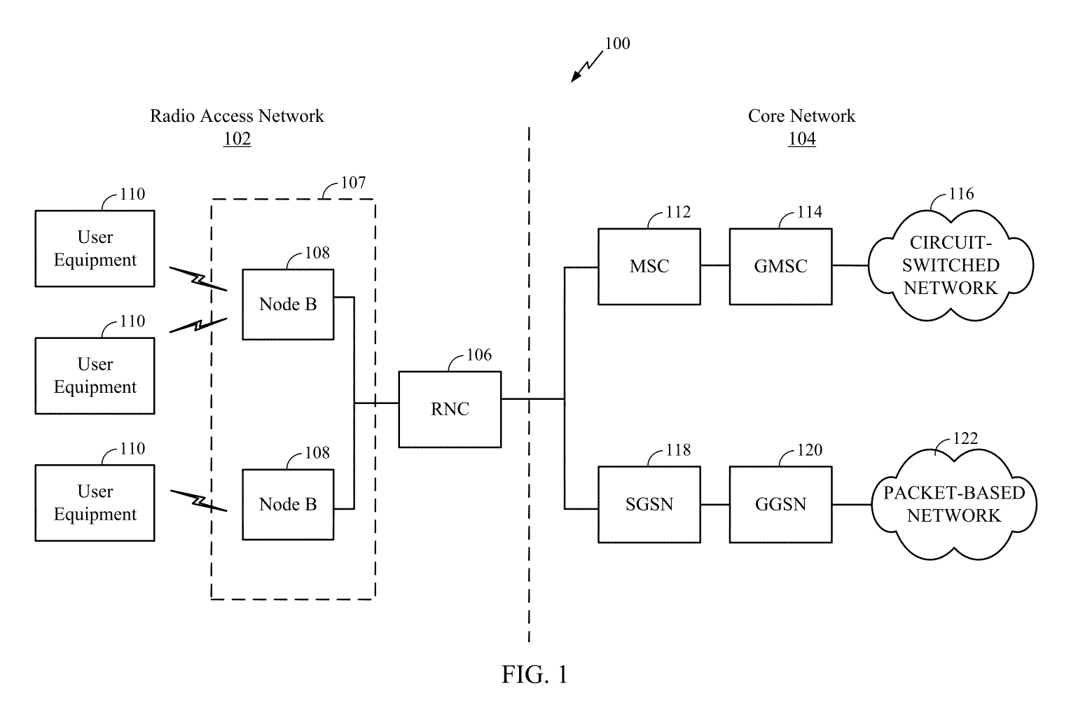

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/WCDMA systems. TDD uses the same carrier frequency for both the uplink (UL) and downlink (DL) between a node B 108 and a UE 110, but divides uplink and downlink transmissions into different time slots in the carrier.

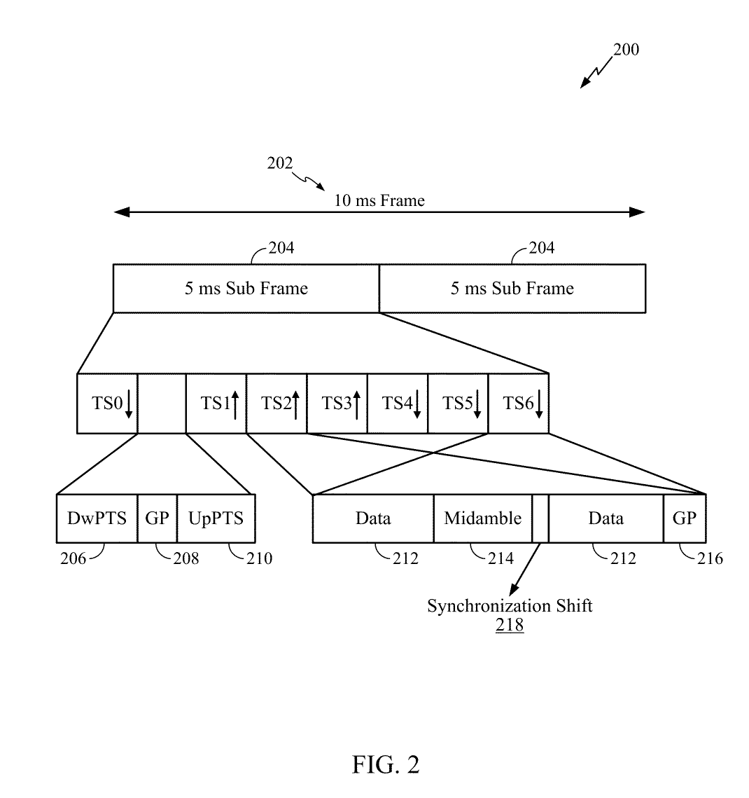

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

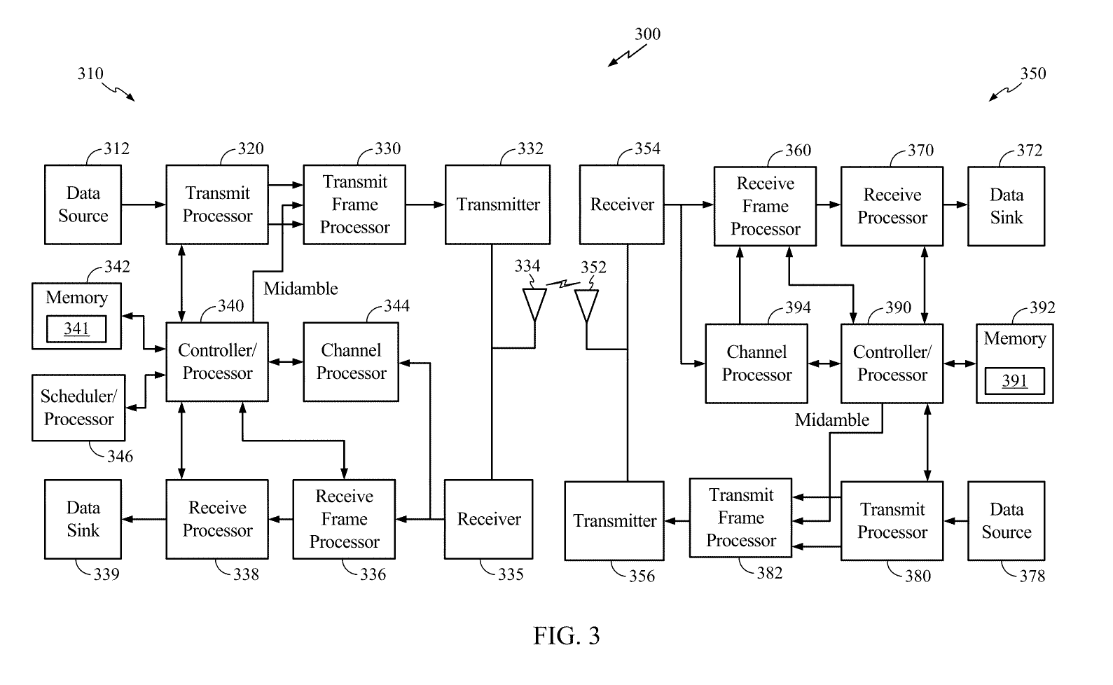

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a random access transmission location module 391 which, when executed by the controller/processor 390, configures the UE 350 for dynamically changing the transmission location of a random access request. In another example, the memory 342 of the node B 310 may store a random access transmission location module 341 which, when executed by the controller/processor 340, configures the node B 340 for informing another radio access technology (RAT) of a location change for a random access channel request location.

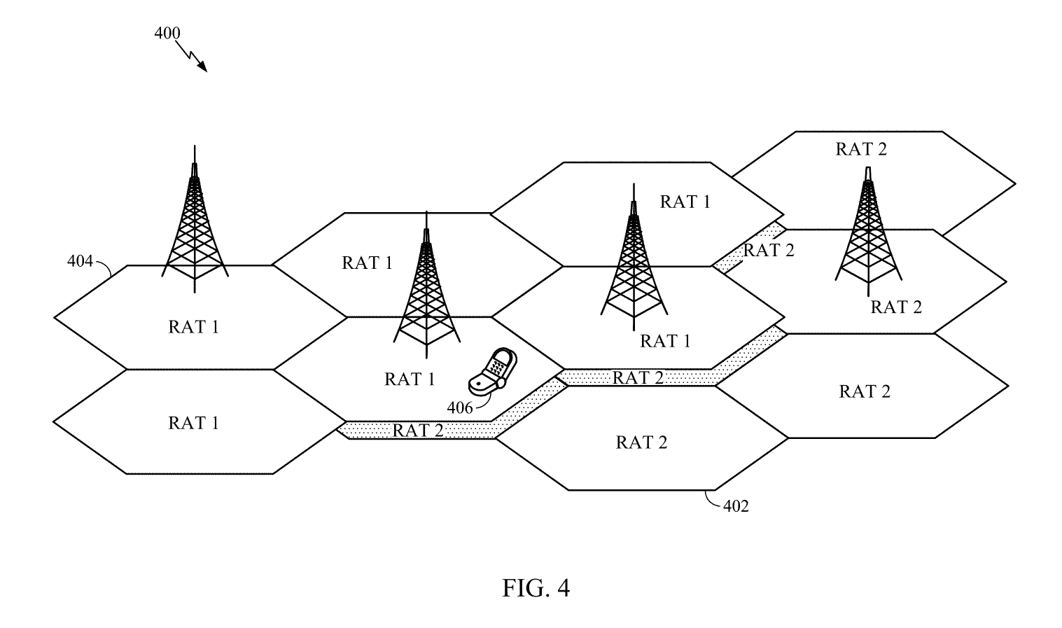

Some networks, such as a newly deployed network, may cover only a portion of a geographical area. Another network, such as an older more established network, may better cover the area, including remaining portions of the geographical area. FIG. 4 illustrates coverage of an established network utilizing a first type of radio access technology (i.e., RAT-1), such as a TD-SCDMA network, and also illustrates a newly deployed network utilizing a second type of radio access technology (i.e., RAT-2), such as an LTE network. The geographical area 400 includes RAT-1 cells 402 and RAT-2 cells 404. In one example, the RAT-1 cells are TD-SCDMA cells and the RAT-2 cells are LTE cells. However, those skilled in the art will appreciate that other types of radio access technologies may be utilized within the cells. A user equipment (UE) 406 may move from one cell, such as a RAT-1 cell 404, to another cell, such as a RAT-2 cell 402. The movement of the UE 406 may specify a handover or a cell reselection.

Handover from a first radio access technology (RAT) to a second RAT may occur for several reasons. First, the network may prefer to have the user equipment (UE) use the first RAT as a primary RAT and to use the second RAT for only a specific function, such as for only voice service(s). Second, there may be coverage holes in the network of one of the RATs. The handover from the first RAT to the second RAT may be based on measurement reporting.

Redirection from one RAT to another RAT commonly occurs, for example, to implement load balancing. Redirection may also be utilized to implement circuit-switched fallback (CSFB) from one RAT, such as Long Term Evolution (LTE) to a second RAT, such as Universal Mobile Telecommunications System (UMTS) frequency division duplex (FDD), UMTS time division duplex (TDD), or GSM.

Circuit-switched fallback is a feature that enables multimode UEs that have, for example, third generation (3G)/second generation (2G) network capabilities in addition to LTE capabilities, to have circuit switched (CS) voice services while being camped on an LTE network. A circuit-switched fallback capable UE may initiate a mobile-originated (MO) circuit-switched (CS) voice call while on LTE. This results in the UE being moved to a circuit-switched capable radio access network (RAN), such as a 3G or 2G network for circuit switched voice call setup. A circuit-switched fallback capable UE may be paged for a mobile-terminated (MT) voice call while on LTE, resulting in the UE being moved to a 3G or 2G network for circuit-switched voice call setup.

Various methods are utilized in an attempt to reduce latency that occurs during circuit-switched fallback call (CFSB) setup. For example, system information block (SIB) tunneling and deferred measurement control reading (DMCR) may be introduced to reduce latency for call setup. For CSFB to UTRAN, the delay related to call setup may increase due to additional signaling on both the LTE and UTRAN sides. A substantial part of the call setup delay results from reading system information on the UTRAN prior to the access.

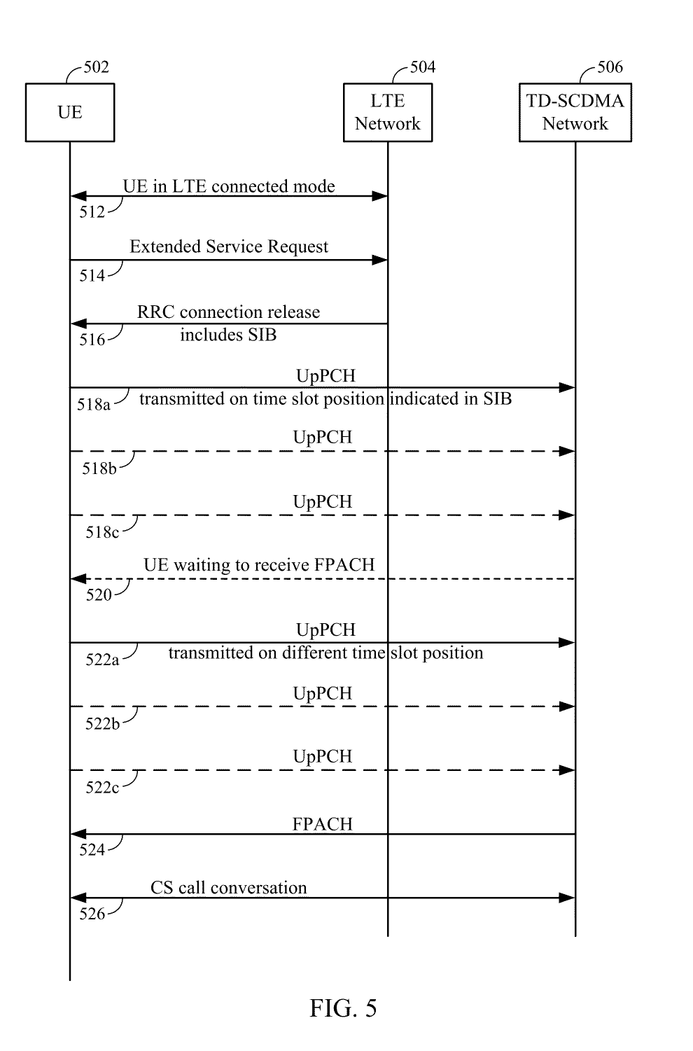

FIG. 5 is a call flow diagram illustrating communications between a UE 502, an LTE network 504 and a TD-SCDMA network 506. At time 512, the UE 502 is in a connected mode with the LTE network 504. At time 514, the UE sends an extended service request message to the LTE Network 504 to indicate it wishes to make a voice call, for example. The LTE network 504 does not support voice calls, and thus sends a radio resource control (RRC) connection release message at time 516.

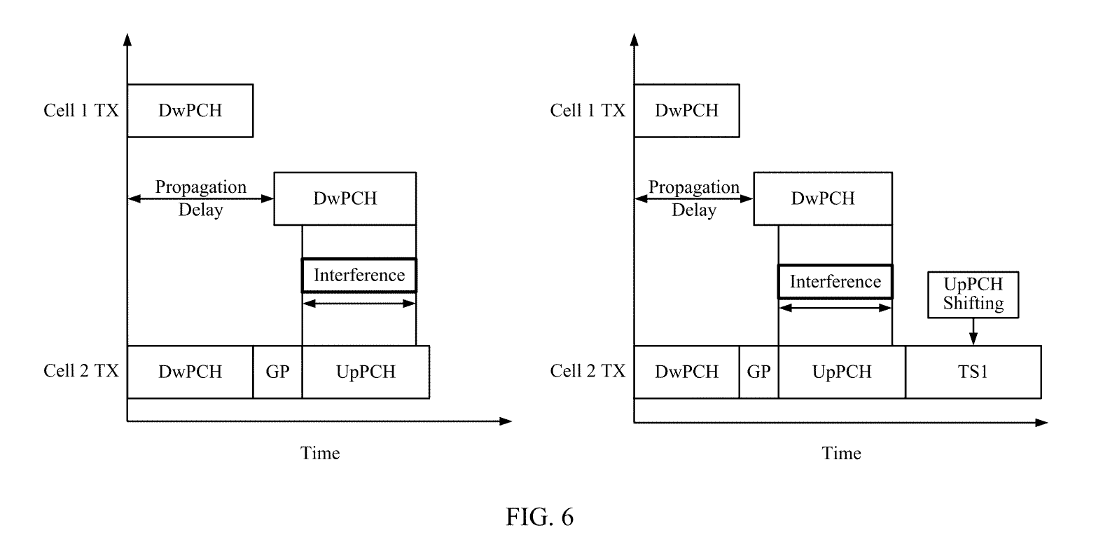

Various types of system parameter information, such as the TD-SCDMA SIBs, are carried in the radio resource control (RRC) release message sent at time 516. The SIBs may include information relating to the uplink pilot channel (UpPCH) positioning, such as the uplink pilot time slot (UpPTS), time slot 1 (TS1) and time slot 2 (TS2). Typically, the TD-SCDMA SIBs for SIB tunneling on the LTE network are static in deployment, whereas, the uplink pilot channel (UpPCH) position may be dynamic. Initially, the UpPCH may be positioned at the uplink pilot time slot (UpPTS). If a neighboring downlink pilot channel (DwPCH) interferes with the UpPTS of the serving cell, for example, due to a propagation delay, the UpCH may be shifted to other uplink (UL) traffic timeslots, such as time slot 1 or 2, as indicated in FIG. 6. The random access channel (RACH) may then be switched, depending on the UpPCH position, to avoid interference.

The TD-SCDMA Node B monitors uplink interference on the UpPTS, time slot 1, and time slot 2 to determine the position of the UpPCH. Still, in some cases, the LTE eNode B and/or network may not be informed of the updated position of the UpPCH. Thus, when a CSFB has been initiated, the UE may use the old UpPCH position indicated in SIB tunneling for random access. That is, the UE may use the old UpPCH position while the TD-SCDMA node B monitors the different UpPCH position. The mismatch of UpPCH positions may result in a RACH procedure failure and CSFB call setup failures.

An aspect of the present disclosure is directed to mitigating RACH procedure failure and CSFB call setup failure. In particular, in one aspect the random access location may be updated by a TD-SCDMA network. For example, if the random access location is incorrect, the UE may attempt a different location. Referring back to FIG. 5, after the UE 502 receives the LTE RRC connection release with a TD-SCDMA SIB for CSFB at time 516, the UE 502 then acquires the TD-SCDMA downlink cell. Next, at time 518a, the UE 502 performs an UpPCH transmission at the time slot position indicated in the SIBs included in the LTE RRC connection release. The UE 502 may transmit the UpPCH multiple times in the same location as illustrated at times 518b and 518c.

At time 520, the UE 502 waits to receive an FPACH from the TD-SCDMA network 506. If, the UE 502 does not receive an FPACH after a maximum allowed number of UpPCH transmissions have been sent, then at time 522a, the UE transmits the UpPCH at other possible positions (or locations). Further, in some aspects, the UE 502 sends additional UpPCH transmissions (e.g. at times 522b, 522c) at the same position as the transmission at time 522a. Once an FPACH is received at time 524, the voice call is set up at time 526.

In one aspect of the present disclosure, when the UE does not receive a FPACH in response to a UpPCH transmission at the time slot indicated in the received SIB, the UE does not declare a failure. Rather, the UE will try another UpPCH position, such as UpPTS, time slot 1, or time slot 2, the UE may also collect the SIB broadcast from the TD-SCDMA network, find the UpPCH position, and then perform a random access process at the UpPCH position indicated in the collected SIB. These aspects of the present disclosure increase the CSFB call setup success rate. According to another aspect of the present disclosure, the TD-SCDMA node B may inform the LTE eNode B/network of the new position of the UpPCH.

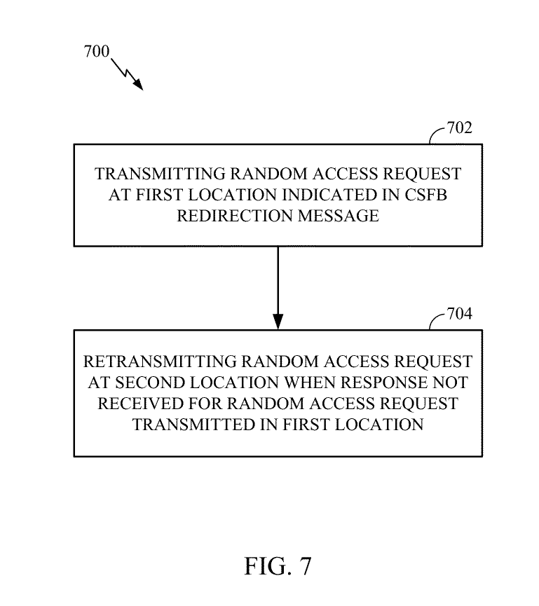

FIG. 7 shows a wireless communication method 700 according to one aspect of the disclosure. A UE transmits a random access request at a first location indicated in a circuit switched fall back redirection message, as shown in block 702. The UE also retransmits the random access request at a second location when a response is not received for the random access request transmitted at the first location, as shown in block 704.

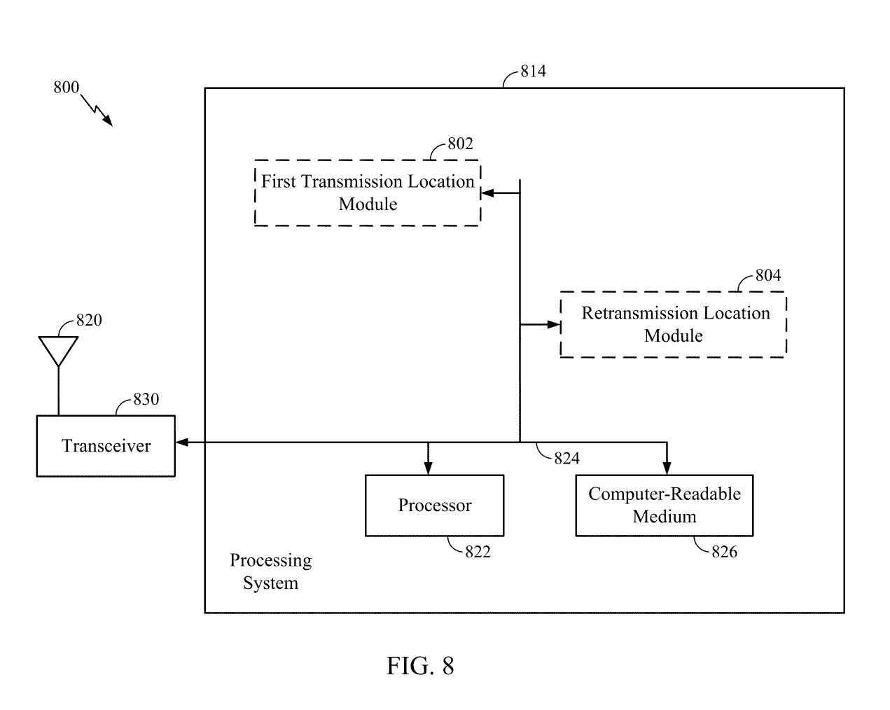

FIG. 8 is a diagram illustrating an example of a hardware implementation for an apparatus 800 employing a processing system 814. The apparatus 800 may be used by a UE. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822 the modules 802, and 804 and the non-transitory computer-readable medium 826. The bus 824 may also link various other circuits such as timing sources, peripherals, voltage regulators, and power management circuits, which are well known in the art, and therefore, will not be described any further.

The apparatus includes a processing system 814 coupled to a transceiver 830. The transceiver 830 is coupled to one or more antennas 820. The transceiver 830 enables communicating with various other apparatus over a transmission medium. The processing system 814 includes a processor 822 coupled to a non-transitory computer-readable medium 826. The processor 822 is responsible for general processing, including the execution of software stored on the computer-readable medium 826. The software, when executed by the processor 822, causes the processing system 814 to perform the various functions described for any particular apparatus. The computer-readable medium 826 may also be used for storing data that is manipulated by the processor 822 when executing software.

The processing system 814 includes a first transmission location module 802 for transmitting a random access request at a first location. The processing system 814 also includes a retransmission location module 804 for retransmitting the random access request at a second location. The modules may be software modules running in the processor 822, resident/stored in the computer readable medium 826, one or more hardware modules coupled to the processor 822, or some combination thereof. The processing system 814 may be a component of the UE 350 and may include the memory 392, and/or the controller/processor 390.

In one configuration, an apparatus such as a UE 350 is configured for wireless communication including means for transmitting a random access request at a first location. In one aspect, the transmitting means may be the antennas 352, the transmitter 356, the transmit frame processor 382, the transmit processor 380, the controller/processor 390, the memory 392, transmission location module 391, first transmission location module 802, and/or the processing system 814 configured to perform the transmitting means. The UE 350 is also configured to include means for retransmitting. In one aspect, the retransmitting means may be the antennas 352, the transmitter 356, the transmit frame processor 382, the transmit processor 380, the controller/processor 390, the memory 392, transmission location module 391, retransmission location module 804 and/or the processing system 814 configured to perform the retransmission means. In one aspect, the aforementioned means may be a module or any apparatus configured to perform the functions recited by the aforementioned means.

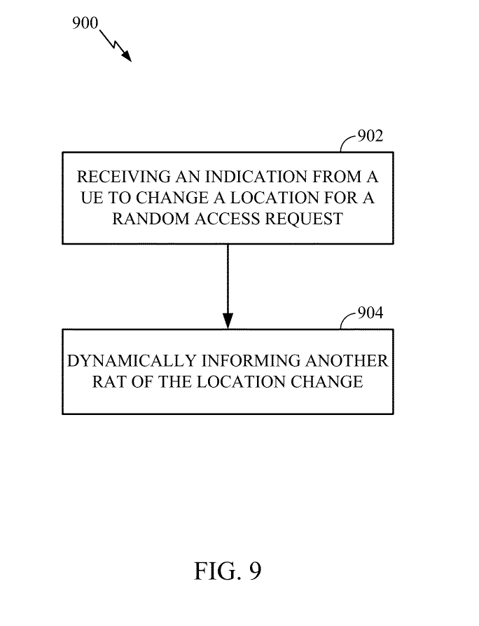

FIG. 9 shows a wireless communication method 900 according to one aspect of the disclosure. In block 902, the node B receives an indication from a user equipment (UE) of a location change for a random access channel (RACH) request. Next, in block 904, the node B dynamically informs another RAT of the location change.

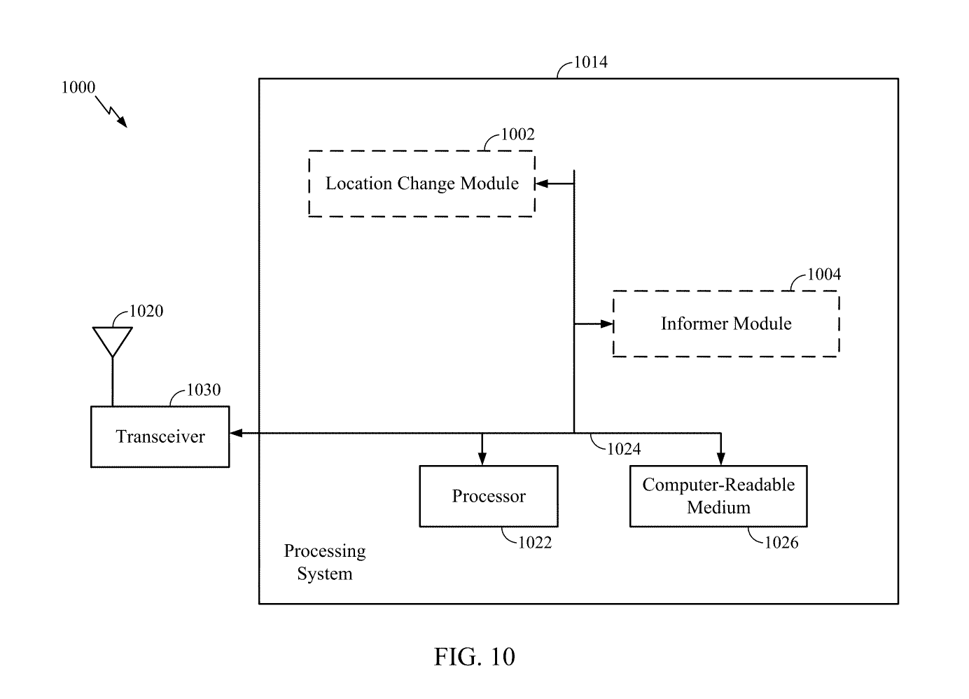

FIG. 10 is a diagram illustrating an example of a hardware implementation for an apparatus 1000 employing a processing system 1014. The apparatus 1000 may be used by a node B. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware modules, represented by the processor 1022, the modules 1002, and 1004 and the non-transitory computer-readable medium 1026. The bus 1024 may also link various other circuits such as timing sources, peripherals, voltage regulators, and power management circuits, which are well known in the art, and therefore, will not be described any further.

The apparatus includes a processing system 1014 coupled to a transceiver 1030. The transceiver 1030 is coupled to one or more antennas 1020. The transceiver 1030 enables communicating with various other apparatus over a transmission medium. The processing system 1014 includes a processor 1022 coupled to a non-transitory computer-readable medium 1026. The processor 1022 is responsible for general processing, including the execution of software stored on the computer-readable medium 1026. The software, when executed by the processor 1022, causes the processing system 1014 to perform the various functions described for any particular apparatus. The computer-readable medium 1026 may also be used for storing data that is manipulated by the processor 1022 when executing software.

The processing system 1014 includes a location change module 1002 for receiving an indication from a UE of a location change for a RACH request. The processing system 1014 includes an informer module 1004 for informing another RAT of the location change. The modules may be software modules running in the processor 1022, resident/stored in the computer readable medium 1026, one or more hardware modules coupled to the processor 1022, or some combination thereof. The processing system 1014 may be a component of the UE 350 and may include the memory 392, and/or the controller/processor 390.

In one configuration, an apparatus such as a node B 310 is configured for wireless communication including means for receiving an indication of a location change for a RACH request. In one aspect, the receiving means may be the antennas 334, the receiver 335, the channel processor 344, the receive frame processor 336, the receive processor 338, the controller/processor 340, the memory 342, random access transmission location module 341, the location change module 1002, and/or the processing system 1014 configured to perform the receiving means. The node B 310 is also configured to include means for informing. In one aspect, the informing means may be the antennas 334, the transmitter 332, the transmit frame processor 330, the transmit processor 320, the controller/processor 340, the memory 342, random access transmission location module 341, informer module 1004 and/or the processing system 1014 configured to perform the informing means. In one aspect, the aforementioned means may be a module or any apparatus configured to perform the functions recited by the aforementioned means.

Several aspects of a telecommunications system have been presented with reference to TD-SCDMA and LTE systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication, comprising
transmitting a random access request at a first location indicated in a circuit switched fall back (CSFB) redirection message; and
retransmitting the random access request at a second location when a response is not received for the random access request transmitted at the first location.

2. The method of claim 1, further comprising retransmitting the random access request at a third location when a response is not received for the random access request transmitted at the second location.

3. The method of claim 1, further comprising:
collecting, by a user equipment (UE), a system information block (SIB) broadcast from a TD-SCDMA network, and
retransmitting the random access request at a location indicated in the collected SIB.

4. The method of claim 1, in which the response is a fast physical access channel (FPACH) message.

5. The method of claim 1, in which the first location is a uplink pilot time slot (UpPTS) position, and the second location comprises another location.

6. The method of claim 1, in which the redirection message is received from a first radio access technology (RAT) and the random access request is transmitted to a second RAT.

7. A method for wireless communication, comprising:
dynamically informing another radio access technology (RAT) of a location change for a random access channel request location.

8. The method of claim 7, in which the location change includes a location different from an uplink pilot time slot (UpPTS) position.

9. The method of claim 7, further comprising dynamically informing the other RAT of a second location change for a random access channel request location.

10. The method of claim 7, in which the other RAT is long term evolution (LTE).

11. An apparatus for wireless communication, comprising:
a memory; and
at least one processor coupled to the memory, the at least one processor being configured:
to transmit a random access request at a first location indicated in a circuit switched fall back (CSFB) redirection message; and
to retransmit the random access request at a second location when a response is not received for the random access request transmitted at the first location.

12. The apparatus of claim 11, in which the at least one processor is further configured to retransmit the random access request at a third location when a response is not received for the random access request transmitted at the second location.

13. The apparatus of claim 11, in which the at least one processor is further configured to collect, by a user equipment (UE), a system information block (SIB) broadcast from a TD-SCDMA network, and
to retransmit the random access request at a location indicated in the collected SIB.

14. The apparatus of claim 11, in which the response is a fast physical access channel (FPACH) message.

15. The apparatus of claim 11, in which the first location is a uplink pilot time slot (UpPTS) position, and the second location comprises another location.

16. The apparatus of claim 11, in which the redirection message is received from a first radio access technology (RAT) and the random access request is transmitted to a second RAT.

17. An apparatus for wireless communication, comprising:
a memory; and
at least one processor coupled to the memory, the at least one processor being configured:
to dynamically informing another radio access technology (RAT) of a location change for a random access channel request location.

18. The apparatus of claim 17, in which the location change includes a location different from an uplink pilot time slot (UpPTS) position.

19. The apparatus of claim 17, in which the at least one processor is further configured to dynamically inform the other RAT of a second location change for a random access channel request location.

20. The apparatus of claim 17, in which the other RAT is long term evolution (LTE).

21. A computer program product for wireless communication in a wireless network, comprising:
a non-transitory computer-readable medium having non-transitory program code recorded thereon, the program code comprising:
program code to transmit a random access request at a first location indicated in a circuit switched fall back (CSFB) redirection message; and
program code to retransmit the random access request at a second location when a response is not received for the random access request transmitted at the first location.

22. A computer program product for wireless communication in a wireless network, comprising:
a non-transitory computer-readable medium having non-transitory program code recorded thereon, the program code comprising:
program code to dynamically informing another radio access technology (RAT) of a location change for a random access channel request location.

23. An apparatus for wireless communication, comprising:
means for transmitting a random access request at a first location indicated in a circuit switched fall back (CSFB) redirection message; and
means for retransmitting the random access request at a second location when a response is not received for the random access request transmitted at the first location.

24. An apparatus for wireless communication, comprising:
means for receiving an indication from a user equipment (UE) to change a location for a random access request; and
means for dynamically informing another radio access technology (RAT) of a location change for a random access channel request location.
